(19) United States
(12) Patent Application Publication
(10) Pub. No.: US 2023/0366514 A1
(43) Pub. Date: Nov. 16, 2023

(54) METHOD FOR OPERATING A DRIVE UNIT OPERATED WITH GASEOUS FUEL

(71) Applicant: Robert Bosch GmbH, Stuttgart (DE)

(72) Inventors: Helerson Kemmer, Vaihingen (DE); Kai Weeber, Heimsheim (DE); Martin SCHULTE MOENTING, Stuttgart (DE)

(21) Appl. No.: 18/247,000

(22) PCT Filed: Nov. 18, 2021
(86) PCT No.: PCT/EP2021/082087

§ 371 Date: Mar. 28, 2023

(30) Foreign Application Priority Data
Nov. 23, 2020 (DE) 10 2020 214 697.7

(51) Int. Cl. F17C 13/04

(52) U.S. Cl. CPC F17C 13/045; F17C 2205/0326; F17C 2223/0123; F17C 2225/036

(57) ABSTRACT

A method for operating a drive unit operated with gaseous fuel. The gaseous fuel is provided under high pressure in a plurality of pressure tanks that can be connected via a supply line and with a metering valve via which the gaseous fuel can be dispensed to the drive unit. One of the pressure tanks is designed as a high-load pressure tank which is only connected to the supply line when the drive unit is under high load, the pressure tanks in which a lower gas pressure prevails than in the high-load pressure tank simultaneously being disconnected from the supply line.

### FIELD

The present invention relates to a method for operating a drive unit operated with gaseous fuel, for example, an internal combustion engine operated with gaseous fuel or a fuel cell operated with gaseous fuel, as is used, for example, in vehicles.

### BACKGROUND INFORMATION

Drive units operated with gaseous fuel are described in the related art. For example, drive units in the form of combustion engines that are operated with gaseous fuel rather than with liquid fuel, in particular with hydrogen or with natural gas, are available in the related art. Moreover, other drive units that are operated with gaseous fuel are available, for example, fuel cells that generate power from the gaseous fuel, which power can be used to drive electric motors. The combustion engines operated with gaseous fuel and the fuel cells comprising an electric motor unit can be used to propel cars or trucks, or also in stationary drive units, such as generators. Since gaseous fuel at normal pressure has only a low energy density per volume, it is either strongly cooled and thereby liquefied or it is compressed to pressures of several 100 bar and stored in corresponding pressure containers. In a vehicle, several pressure tanks are usually used, which has various advantages. On the one hand, relatively small pressure tanks, for example, gas cylinders, can be manufactured with a relatively small wall thickness, while significantly greater wall thicknesses and further stabilizing elements are required in large gas tanks. On the other hand, small pressure tanks can be arranged more easily in a vehicle and thus make better use of the given installation space. Such an arrangement is, for example, described in German Patent Application No. DE 10 2017 212 485 A1

A certain gas pressure is required to supply the drive unit operated with the gaseous fuel. Especially when the drive unit is at high load, a lot of gaseous fuel has to be supplied in a short time, which can only be accomplished with a certain minimum pressure. If the gas tanks are already partially empty as a result of prolonged operation, it may happen that the still available gas pressure is no longer sufficient to also supply sufficient fuel to the combustion engine or to the other drive unit operated with the gaseous fuel at very high load, so that the maximum load can no longer be requested.

### SUMMARY

A method according to the present invention for operating a drive unit operated with gaseous fuel may have the advantage that even after prolonged operation of the drive unit, the full load, at which a lot of gaseous fuel is required in a short time, can be requested. According to an example embodiment of the present invention, in the method, the gaseous fuel is provided under high pressure in a plurality of pressure tanks that can be connected via a supply line to a metering valve via which the gaseous fuel can be dispensed to the drive unit. One of the pressure tanks is designed as a high-load pressure tank which is only connected to the supply line when the drive unit is at high load, wherein the pressure tanks in which a lower gas pressure prevails than in the high-load pressure tank are simultaneously disconnected from the supply line.

For example, according to an example embodiment of the present invention, the pressure tanks are filled with hydrogen under an initial pressure of 700 bar (70 MPa). By operating the drive unit, the gaseous fuel is gradually consumed and, accordingly, the pressure in the pressure tanks decreases. If all pressure tanks are emptied evenly, the pressure also decreases in all pressure tanks until it falls below a critical level. If the drive unit is now operated under full load, which is accompanied by a high rotational speed in the case of a combustion engine, a lot of gaseous fuel is needed in a short time, which must be introduced into the corresponding combustion chambers of the combustion engine. If the pressure tanks no longer provide the necessary pressure for this purpose, the maximum power output of the drive unit can no longer be requested.

According to the present invention, it is therefore provided to operate one or more pressure tanks as a high-load pressure tank and to connect them to the supply line only if the drive unit is to be operated under full load or under high load. The remaining pressure tanks in which a lower pressure prevails are disconnected from the supply line at full load. If a lower power output of the drive unit is subsequently requested again, the high-load pressure tanks (or the high-load pressure tank) are disconnected from the supply line again and the remaining pressure tanks are connected to the supply line since a lower gas pressure is sufficient for these operating points. In this way, even if the pressure tank is already partially empty, a sufficiently high gas pressure is always available, which is required in order to be able to request the maximum power output of the drive unit without further structural measures, for example, an intermediate compressor.

In a development of the method according to the presnt invention, the high-load pressure tank is connected to the supply line only if the gas pressure in the remaining pressure tanks is no longer sufficient to supply the drive unit at high load. This ensures that the high-load pressure tank maintains its full gas pressure for as long as possible and is thus available for the realization of maximum load situations of the drive unit.

In a development of the method according to the present invention, each of the pressure tanks can be connected to the supply line via a connecting line, wherein a shut-off valve is arranged in each connecting line. The shut-off valves, which can preferably be controlled electrically, allow each pressure tank to be individually connected to or disconnected from the supply line. In terms of safety, this is also desirable in order to be able to interrupt the corresponding connection in the case of a defect of a pressure tank. The free controllability of the shut-off valves allows one or more of the pressure tanks to be operated as a high-load pressure tank, i.e., these pressure tanks are used only when the drive unit is at a maximum or full load, while the remaining pressure tanks are provided for normal operation.

In a development of the method according to the present invention, there are several high-load pressure tanks, at least one of which is connected to the supply line when the drive unit is under high load. For example, if two of the pressure tanks are provided as a high-load pressure tank, only one of the high-load pressure tanks can first be connected to the supply line in case the drive unit is at full load. After exhausting the gas supply in this high-load pressure tank, the second high-load pressure tank assumes this task. As a result, a high pressure level in the high-load pressure tanks can be maintained for an extended period of time and is available to the drive unit. Alternatively, it may also be provided that all high-load pressure tanks are always connected together to the supply line.

If several high-load pressure tanks are provided and only one is connected to the supply line in each case, only one of the high-load pressure tanks is emptied when the drive unit is at full load, until the same gas pressure prevails in these high-load pressure tanks as in the remaining pressure tanks used when the drive unit is at the normal operating load.

In an advantageous development of the method of the present invention, the drive unit operated with gaseous fuel is an internal combustion engine or a fuel cell comprising an electric motor supplied with power by the fuel cell. In both cases, gaseous fuel under a particular pressure is required in order to maintain the function so that the method according to the invention ensures permanent operation and optimal utilization of the existing gaseous fuel in the pressure tanks.

In a development of the method according to the present invention, a pressure reducer is arranged in the supply line between the pressure tanks and the metering valve. This pressure reducer ensures an optimal gas pressure for operating the metering valve, depending on the operating point of the drive unit. If the pressure in the pressure tanks decreases too much, the pressure reducer can also be deactivated so that the full pressure of the pressure tanks is available at the metering valve.

In a development of the method according to the present invention, several metering valves are provided and connected to the supply line in order to supply gaseous fuel to, for example, several cylinders of a combustion engine, or also to several fuel cells.

### BRIEF DESCRIPTION OF EXAMPLE EMBODIMENTS

The figures show various exemplary embodiments of devices that can be operated using the method according to example embodiments of the present invention.

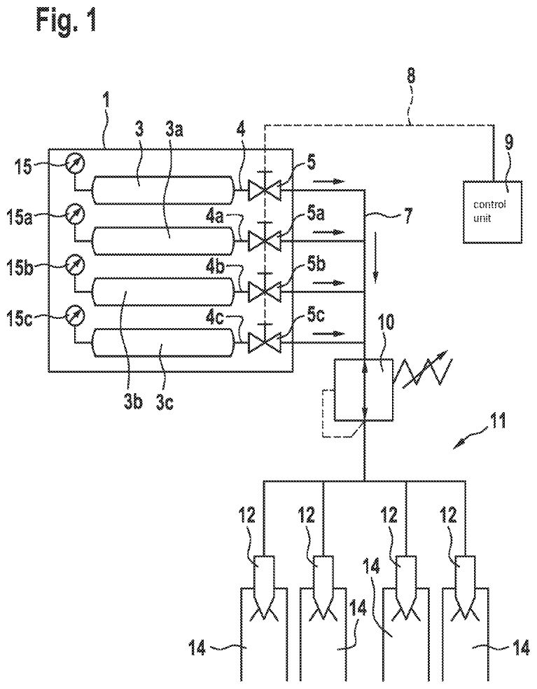

FIG. 1 shows a schematic representation of a drive unit operated with gaseous fuel, together with a pressure tank assembly for supplying this drive unit, according to an example embodiment of the present invention.

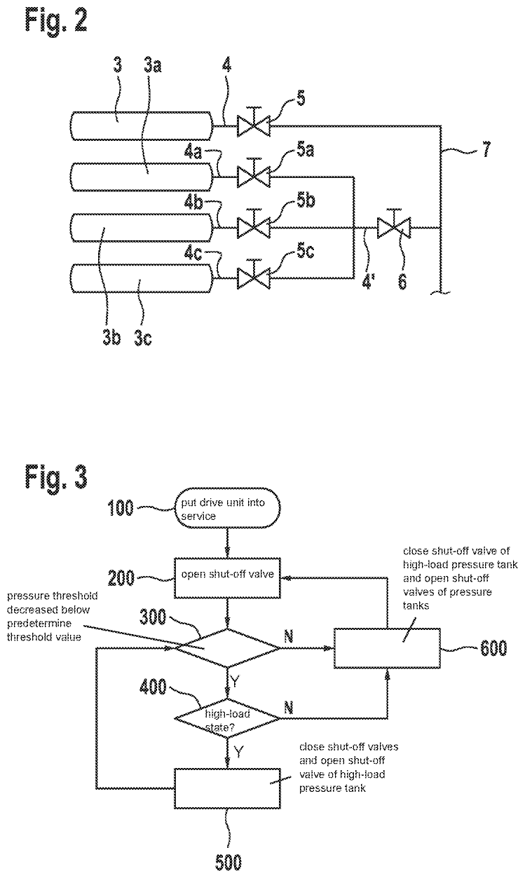

FIG. 2 shows a further exemplary embodiment of a pressure tank assembly with alternative circuitry of the individual pressure tanks, according to an example embodiment of the present invention.

FIG. 3 shows a flow chart for illustrating the method according to the present invention, according to an example embodiment of the present invention.

### DETAILED DESCRIPTION OF EXAMPLE EMBODIMENTS

In order to explain the method according to the invention, a drive unit, which is operated with gaseous fuel, is schematically shown in FIG. 1. The drive unit 11 is designed as an internal combustion engine here and comprises four combustion chambers 14, into each of which a metering valve 12 opens. Gaseous fuel can be metered via the metering valve 12 into the respective combustion chamber 14, where the gaseous fuel combusts and in each case moves a piston in a conventional manner. A pressure tank assembly 1 is provided to supply gaseous fuel to the drive unit 11. The pressure tank assembly 1 comprises several pressure tanks 3, 3a, 3b, 3c, of which the pressure tank 3 is used as a high-load pressure tank 3, wherein the high-load pressure tank 3 is otherwise not structurally different from the remaining pressure tanks 3a, 3b and 3c. The pressure tanks 3, 3a, 3b, 3c are substantially formed in the form of high-pressure gas cylinders, wherein the gas pressure within the pressure tanks 3, 3a, 3b, 3c is measured by a respective pressure sensor 15, 15a, 15b, 15c, which transmit their measured values to a control unit 9, which is schematically shown in FIG. 1.

In order to supply the drive unit 11 with the gaseous fuel, all pressure tanks 3, 3a, 3b, 3c are connected via connecting lines 4, 4a 4b, 4c to a supply line 7, which branches toward the individual metering valves 12. In the connecting lines 4, 4a, 4b, 4c, a respective shut-off valve 5, 5a, 5b, 5c is arranged, which can be controlled electrically and are connected to the control unit 9 via an electrical connecting line 8. The individual shut-off valves 5, 5a, 5b, 5c can thus be opened and closed independently of one another. In the supply line 7, a pressure reducer 10 is arranged, by means of which the required pressure of the gaseous fuel at the metering valves can be adjusted if the gaseous fuel delivered from the pressure tanks has too high a gas pressure.

The method according to the present invention for operating the drive unit and for supplying the drive unit with gaseous fuel is explained in more detail with reference to the flow chart of FIG. 3. In a first step 100, the drive unit is put into service, i.e., the combustion engine is started, for example. In a second step 200, the shut-off valve of at least one pressure tank 3a, 3b, 3c is opened; generally, when the combustion engine is at a normal load state, one of the shut-off valves 5a, 5b, 5c is opened, while the shut-off valve 5 of the high-load pressure tank 3 remains closed.

In a next step 300, it is checked whether the pressure threshold value of the pressure tanks 3a, 3b, 3c has decreased below a predetermined threshold value at which the supply of the drive unit 11 is no longer ensured at maximum load. This takes place on the basis of the pressure that the individual pressure sensors 15a, 15b, 15c measure and transmit to control unit 9. If the pressure in the pressure tanks 3a, 3b, 3c is sufficient (branch “N”), the shut-off valve 5 remains closed (step 600) and the shut-off valves 5a, 5b, 5c remain open so that the drive unit, here the internal combustion engine, continues to be supplied with the gaseous fuel from the pressure tanks 3a, 3b, 3c. If, however, the pressure in the pressure tanks 3a, 3b, 3c drops below a threshold value (branch “Y”), it is checked in the following step 400 whether the drive unit 11 is in a high-load state. If not (branch “N”), the shut-off valves 5a, 5b, 5c remain open and the shut-off valve 5 remains closed. If yes (branch “Y”), in a step 500, the shut-off valves 5a, 5b, 5c are closed and the shut-off valve 5 is opened so that gaseous fuel now flows under high pressure from the high-load pressure tank 3 into the supply line 7 and from there to the metering valves 12. The pressure reducer 10 is only used if the gas pressure is too high. Subsequently, the method steps of testing the pressure threshold value in the pressure tanks 3a, 3b, 3c in step 300 and the subsequent steps are passed through again until the control unit detects that the drive unit 11 is no longer at full or maximum load. If this is determined, in a step 600, the shutoff valve 5 of the high-load pressure tank is closed and the shutoff valves 5a, 5b, 5c of the pressure tanks 3a, 3b, 3c are reopened.

FIG. 2 shows an alternative circuitry of the pressure tanks 3a, 3b, 3c. Instead of directly connecting each connecting line 4a, 4b, 4c with a shut-off valve 5a, 5b, 5c to the supply line, the connecting lines 4a, 4b, 4c here open into a further connecting line 4′, in which a normal shut-off valve 6 is arranged. In this case, the connection of the pressure tanks 3a, 3b, 3c to the supply line 7 can be interrupted by the normal shut-off valve 6, while the shut-off valves 5a, 5b, 5c can remain constantly open even in full-load cases.

In the pressure tank assembly 1 shown here, four pressure tanks 3, 3a, 3b, 3c are provided, one of which is formed as a high-load pressure tank 3. It does not have to be structurally different from the remaining pressure tanks 3a, 3b, 3c but only becomes a high-load pressure tank as a result of its use and assumes supplying the drive unit at full load. It may also be provided to use a greater number of pressure tanks and to operate more than one of the pressure tanks as a high-load pressure tank. For example, if two pressure tanks are provided as high-load pressure tanks, one of the high-load pressure tanks can first assume the task of providing the necessary gaseous fuel pressure when the drive unit is at full load, until the pressure level in this high-load pressure tank is no longer sufficient. Then, the second high-load pressure tank can be used, which then ensures the supply of the drive unit 11 even at full load and, if the drive unit is a combustion engine, at very high rotational speeds.

1-10. (canceled)

11. A method for operating a drive unit operated with gaseous fuel, the gaseous fuel being provided under high pressure in a plurality of pressure tanks that can be connected via a supply line and with a metering valve via which the gaseous fuel can be dispensed to the drive unit, the method comprising the following steps:
providing one of the pressure tanks as a high-load pressure tank, which is connected to the supply line only at high load of the drive unit;
simultaneously disconnecting from the supply line the pressure tanks in which a lower gas pressure than in the high-load pressure tank prevails.

12. The method according to claim 11, wherein the high-load pressure tank is connected to the supply line only when the gas pressure in the remaining pressure tanks is no longer sufficient to supply the drive unit at high load.

13. The method according to claim 11, wherein each of the pressure tanks can be connected to the supply line via a connecting line, wherein a shut-off valve is arranged in each connecting line.

14. The method according to claim 13, wherein the shut-off valves are controlled electrically.

15. The method according to claim 11, wherein several high-load pressure tanks are present, at least one of which is connected to the supply line when the drive unit is at high load.

16. The method according to claim 15, wherein all of the high-load pressure tanks are always connected together to the supply line.

17. The method according to claim 15, wherein only one of the high-load pressure tanks is connected to the supply line when the drive unit is at high load, until the one of the high-load pressure tanks has the same gas pressure as the remaining pressure tanks, and a next one of the high-load pressure tanks is subsequently connected to the supply line when the drive unit is at high load.

18. The method according to claim 11, wherein the drive unit operated with gaseous fuel is an internal combustion engine or a fuel cell including an electric motor powered by the fuel cell.

19. The method according to claim 11, wherein a pressure reducer is arranged in the supply line between the pressure tanks and the metering valve.

20. The method according to claim 11, wherein several metering valves are connected to the supply line.
